(19) United States
(12) Patent Application Publication
(10) Pub. No.: US 2022/0010825 A1
(43) Pub. Date: Jan. 13, 2022

(54) INSTALLATION CLIP, ESPECIALLY FOR INSTALLING PLANKS, AND ASSOCIATED INSTALLATION SYSTEM

(71) Applicant: Götz S. Schmitt, Achim (DE)

(72) Inventor: Marcus VOß, Schwerte (DE)

(21) Appl. No.: 17/227,761

(22) Filed: Apr. 12, 2021

(30) Foreign Application Priority Data
Jul. 10, 2020 (EP) 20185319.9

(51) Int. Cl. F16B 5/00; E04F 15/02; E04F 15/04; E04F 13/08; E04F 13/10

(52) U.S. Cl. CPC F16B 5/0092; E04F 15/02044; E04F 2015/02122; E04F 13/0846; E04F 13/10; E04F 15/04

(57) ABSTRACT

An installation clip for installing assembly pieces includes a holding arrangement with a first holding element and a second holding element that are arranged symmetrically inside the holding arrangement. The first holding element is configured to interlock with a first receiving element of a first assembly piece and the second holding element is configured to interlock with a second receiving element of a second assembly piece. The first holding element and the second holding element are configured elastically to be held by a preload inside the first receiving element and the second receiving element.

### CROSS-REFERENCE TO RELATED APPLICATIONS

This application claims priority to European patent application Serial No. 20185319.9 filed Jul. 10, 2020, the disclosure of which is hereby incorporated in its entirety by reference herein.

### TECHNICAL FIELD

The present invention concerns an installation clip for installing assembly pieces, especially for installing planks, in a vertical or horizontal plane.

### BACKGROUND AND SUMMARY

These days many residential apartments or even terraces are equipped with wood floors or wood walls. Often, these consist of wood floors or wood walls made of panels, tiles or planks that have to be connected to one another during installation. One way of connecting the panels, tiles or planks to one another includes designing the individual elements such that they interlock in a positive-locked manner. By relying on a design of correspondingly interlocking shapes, installation is simplified; however, the flexibility of the potential design of the wood floors and/or wood walls is limited since the assembly pieces can only be individually set up with significant effort and high costs.

Alternatively or in addition, installation can be done by means of so-called installation clips. Such an installation clip is usually used to connect from two to four assembly pieces, such as panels, tiles or planks with one another. The installation clip has a holding element for this purpose, which interacts mechanically with a receiving element of the assembly piece and thereby establishes a (mechanical) connection. Since installation clips are sold as separate elements, the use of such installation clips increases the flexibility of the arrangement and form of the assembly pieces upon installation. One disadvantage is that the installation clips are brought into connection with the assembly pieces in a “loose” manner and can slip out of their position or even fall out. This makes installation more difficult and can increase the probability of errors.

The present disclosure seeks to solve the problem of enabling an installation of assembly pieces, especially of planks, that does not have the disadvantages mentioned above. In particular, the disclosure seeks to solve the problem of providing an installation clip with which installation can be rendered easier than with the installation clips known from the prior art.

According to one or more embodiments of this disclosure, this problem is solved by an installation clip of the type mentioned above that is characterized in that it comprises a holding arrangement with a first holding element and a second holding element, wherein the first and the second holding element are arranged symmetrically within the holding arrangement. The first holding element is configured to interlock with a first receiving element of a first assembly piece and the second holding element is configured to interlock with a second receiving element of a second assembly piece. The first holding element and the second holding element are configured elastically, in order to be held in a preloaded state inside the first receiving element and the second receiving element.

A holding arrangement is to be understood, in particular, as an arrangement that holds the assembly pieces, especially planks. For this purpose, the holding arrangement has two holding elements that are arranged symmetrically on both sides of the holding arrangement. The holding arrangement is therefore designed symmetrically relative to a theoretical plane passing through the center of the holding arrangement. This centrally extending plane therefore represents a type of mirror plane, on both sides of which identically designed holding elements are arranged.

These two holding elements, below referred to as a first and second holding element, are configured respectively to interlock with a receiving element, below referred to as a first and second receiving element. The first receiving element belongs to a first assembly piece, such as a first plank, and the second receiving element belongs to a second assembly piece, such as a second plank. The first and the second receiving element of the first and second assembly piece serve, respectively, to receive the first and the second holding element. In one embodiment, the first and the second receiving element are configured as a first and second groove inside the first and second assembly piece, for example, or comprise at least a first and a second groove.

The first and the second holding element are implemented as being elastic in design in order to be held within the first receiving element and the second receiving element by means of a preload. This means that the first and the second holding element are con-figured such that they mechanically interact with the first and second receiving element, and do so in a manner in which the first holding element and the second holding element create a preload within the first and the second receiving element. This preload serves to hold the first holding element inside the first receiving element and to hold the second holding element inside the second receiving element. On the other hand, since preload is used contrary to clamping with higher tensioning force, the first and the second holding element can be removed again from the first and the second receiving element when necessary, such as in the event of incorrect installation or for other reasons.

With the new installation clips it is possible to install two adjacent assembly pieces, especially two adjacent planks, along a horizontal or a vertical direction. It is possible, therefore, to use the installation clip both when installing a floor, especially a wood floor, especially a terrace, as well as when installing a wall, especially a wood wall, and further, especially a cladding. Due to the specialized form of the holding elements, such that they create a preloaded state, the installation clip is held in position inside the respective receiving element, especially the respective groove, of the assembly piece, especially the plank, by the preload even before actual installation. This allows the installation clip to be brought into position in advance and remain independently in this position.

Furthermore, the elastic holding elements of the installation clip enables an automatic centering of the installation clip between the assembly pieces, whereby installation of the assembly pieces is made easier and an especially good, precise arrangement of the assembly pieces relative to one another can be achieved. In particular, due to their design, the first holding element and the second holding element are not only capable of holding the assembly piece, but rather also act as spacers between the assembly pieces, such that with the installation clip an even spacing between the individual assembly pieces can be effected.

In some embodiments, the installation clip further comprises a fastening arrangement with a fastening recess for a fastening means. Such a fastening means serves the purpose of final fastening of the installation clip between the assembly pieces. The fastening means can comprise, in particular, a screw, or be implemented as such, wherein the fastening recess of the fastening arrangement can comprise a corresponding thread into which the screw can be turned. The fastening means, in particular the screw, can be provided separate from the installation clip or pre-mounted inside the installation clip, such that an installation system consisting of an installation clip and fastening means is provided.

Providing the fastening means, in particular the screw, in a pre-mounted manner inside the installation clip is especially advantageous. This enables the installation clip to be provided directly with a matching fastening means that already interacts with the installation clip such that it only has to be tightened to achieve the fastening. This avoids incorrect installations, for example due to imprecise or incorrect installation of the fastening means. Furthermore, providing a pre-mounted fastening means, especially a pre-mounted screw, increases the efficiency of installing the assembly pieces, since here the otherwise additionally needed step of attaching the installation clip to the fastening means can be dispensed with.

Such an arrangement makes it possible to tighten the fastening means, especially the screw, for final fastening. Through this tightening, the first and the second holding element, both of which are elastic in design, change their shape. This makes it possible to adjust the installation clip to the respectively desired height of the assembly pieces, in particular, to the height of the planks. This means a single installation clip can be used for assembly pieces with different heights.

The first holding element may be configured as a first wing and the second holding element may be configured as a second wing. Here, the first wing may comprise a first upper preloading element and a first lower preloading element, wherein the first upper and the first lower preloading element are disposed opposite one another in order to create the preloading for the first holding element when it is received in the first receiving element. Furthermore, the second wing may comprise a second upper preloading element and a second lower preloading element, wherein the second upper and the second lower preloading element are disposed opposite one another, in order to create the preloading for the second holding element when it is received in the second receiving element.

In some embodiments, the first holding element and the second holding element are designed as a first and second wing, in particular, and therefore extend in the shape of wings from a central plane of the holding arrangement. Here the first wing may comprise a first upper preloading element and a first lower preloading element, and the second wing correspondingly comprises a second upper preloading element and a second lower preloading element. The upper and the lower preloading element work together to create the preload within the respective receiving element.

In some embodiments, the holding arrangement may include a sheet metal or a metal part, whereby two sheet metal pieces extend symmetrically from the center of the holding arrangement. These sheet metal pieces can be bent by around 180° degrees at their respective center, in order to create the two holding elements with the upper and the lower preloading element. Here, the preloading is created by the upper and the lower preloading element approaching one another upon insertion into the recess. Due to the spring force working against this mutual approaching, the holding element is then pre-loaded inside the receiving element. In this way, the installation clip can be held in position “automatically” inside the receiving element between the assembly pieces until final fastening.

In one or more embodiments, the first holding element may have a first spacing element and the second holding element may have a second spacing element, wherein the first spacing element is configured to set a penetration depth of the first holding element into the first receiving element, and wherein the second spacing element is configured to set a penetration depth of the second holding element into the second receiving element, in order to establish a spacing between the assembly pieces in this manner.

In some embodiments, the first and second holding element further comprise a spacing element, which works as a “stop” for inserting the holding element into the receiving element. To this end, the spacing element may extend at a right angle to the insertion direction of the holding element. This enables the respective holding element to be inserted into the respective receiving element. However, it is kept from being further inserted when the spacing element hits the outer side of the receiving element.

By shaping the first and the second spacing element in such a way, especially such that they extend at a right angle to the insertion direction of the holding element, a correct installation position of the installation clip can be guaranteed. Furthermore, providing the first and the second spacing element automatically ensures that the spacing between the assembly pieces, especially the groove space between the planks, is set correctly. It must be taken into account that, for different spacing distances, different arrangements of the first and of the second spacing element at the first and second holding element are necessary, such that the shape of the installation clip can be varied in this regard.

This design is therefore especially advantageous for achieving the automatic centering of the installation clip between the assembly pieces and the especially attractive and precise arrangement of the assembly pieces relative to one another. In particular, the wings act as spacers between the assembly pieces. Furthermore, the preload acting on the holding element effects proper orientation of the installation clip.

The first receiving element may comprise a first groove and the second receiving element may comprise a second groove, wherein the first holding element and the second holding element are configured to interact with the first groove and the second groove, thereby respectively creating the preload.

In some embodiments, the holding arrangement further comprises a third holding element and a fourth holding element, wherein the third and the fourth holding element are also symmetrically arranged within the holding arrangement, wherein the third holding element is configured to interlock with the first receiving element of the first assembly piece and the fourth holding element is configured to interlock with the second receiving element of the second assembly piece, wherein the third holding element and the fourth holding element are configured elastically, in order to be held inside the first receiving element and the second receiving element by means of a preload.

In some embodiments, the installation clip can also be designed such that it comprises four holding elements. The first and the second holding element can be arranged symmetrically relative to one another, wherein the symmetry exists along a theoretical first plane of symmetry through the center of the holding arrangement. Likewise, the third and the fourth holding element can be arranged symmetrically relative to one another, where-by the symmetry exists along the first theoretical plane of symmetry through the center of the holding arrangement.

In some embodiments, furthermore, the first and the third holding element, and the second and the fourth holding element, respectively, can be arranged symmetrically relative to one another, wherein a second theoretical plane of symmetry that runs orthogonal to the first theoretical plane of symmetry exists.

In some embodiments, however, the first and the third, as well as the second and the fourth holding element, respectively, can also be arranged such that they are arranged sequentially along a normal of the first plane of symmetry, i.e., first the first holding element, and then the third holding element, is arranged along the normal, and on the other side of the first plane of symmetry, first the second holding element and then the fourth holding element are arranged along the normal. The symmetry along the plane of symmetry between the first and the third, and the second and the fourth holding element also exists in this case.

In both cases, the third and the fourth holding element can be configured correspondingly here to also interact with the first and the second receiving element, respectively. In particular, the third and the fourth holding element are configured exactly as described in connection with the above-mentioned embodiments for the first and the second holding element.

In another aspect of this disclosure, an installation system for installing assembly pieces, especially for installing planks, comprising an installation clip according to any one of the embodiments described above, and a fastening element that is configured to be received in the fastening recess. In some embodiments, the fastening element is further configured to set a height of the first assembly piece and/or of the second assembly piece. In some embodiments, the fastening element especially comprises a screw.

The installation clip can be provided in the form of an installation system with an already pre-mounted fastening means, especially a screw. This allows installation to be done significantly more rapidly and efficiently. The screw is held in position here by the holding arrangement inside the fastening recess and can be tightened in this manner. As described above, through this tightening, the elastic holding elements of the holding arrangement can be changed, such that by tightening, on the one hand, a fastening of the assembly pieces is effected, and on the other, the height of the assembly pieces can be set.

In yet another aspect of this disclosure, an arrangement of at least one installation system according to any one of the embodiments described above and at least two assembly pieces, wherein the at least two assembly pieces can be installed horizontally or vertically using the at least one installation system.

In a further aspect of this disclosure, a method for producing an installation clip for installing assembly pieces, especially for installing planks, comprises the following steps: providing a holding arrangement with a first holding element and a second holding element, comprising: symmetrically arranging the first holding element and the second holding element inside the holding arrangement, forming the first holding element in order to interlock with a first receiving element of a first assembly piece, and forming the second holding element in order to interlock with a second receiving element of a second assembly piece. The method further comprises forming the first holding element and the second holding element as elastic elements that are configured to be held inside the first receiving element and the second receiving element by means of a preload.

In another aspect of this disclosure, a method for installing assembly pieces, especially for installing planks, compromises providing at least one installation clip according to any one of the embodiments described above, providing at least one fastening element that is configured to be received in the fastening recess of the at least one installation clip, and connecting the at least one fastening element to the fastening recess of the at least one installation clip in order to install the assembly pieces. In one embodiment, the method further comprises varying of an installation height of the installation clip by setting the at least one fastening element in the fastening recess of the at least one installation clip.

In a further aspect of this disclosure, the use of at least one installation clip according to any one of the embodiments described above for installing assembly pieces by means of an installation system according to any one of the embodiments described above.

It should be understood that embodiments of the installation clip according to this disclosure correspond to embodiments of the further aspects of the disclosure, which are not described in more detail above or below.

### BRIEF DESCRIPTION OF THE DRAWINGS

FIG. 1 is a lateral view of an installation clip according to a first embodiment;

FIG. 2 is a lateral view of an installation system according to an embodiment, arranged in an assembly piece;

FIG. 3 is a top-down view of an installation clip according to a second embodiment;

FIG. 4 is a top-down view of an installation system according to a second embodiment, arranged in an assembly piece;

FIG. 5 is a top-down view of an installation clip according to a third embodiment;

FIG. 6 is a top-down view of an installation clip according to a fourth embodiment;

FIG. 7A is a lateral view of an installation system with an installation clip of the fourth embodiment in a first setting; and

FIG. 7B is a lateral view of an installation system with an installation clip of the fourth embodiment in a second setting.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

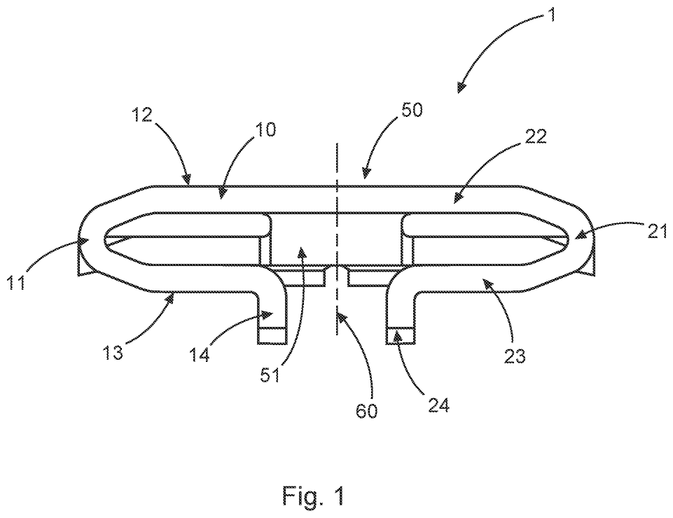

FIG. 1 shows a lateral view of an installation clip 1 according to a first embodiment of the disclosure. The installation clip 1 comprises a holding arrangement 10, a first holding element 11, a second holding element 21 as well as a fastening arrangement 50. The fastening arrangement 50 comprises a fastening recess 51 for receiving a fastening element (not shown in FIG. 1). In the specific embodiment according to FIG. 1, the fastening recess 51 is designed as a thread that is configured to receive a screw, for example, as a fastening element.

The first holding element 11 comprises a first upper preloading element 12 and a first lower preloading element 13. The holding element 11 further comprises a first spacing element 14. In the embodiment according to FIG. 1, the first holding element 11 is designed as a wing. This wing may be provided by bending a corresponding sheet metal by approximately 180°, such that the first upper preloading element 12 and the first lower preloading element 13 are formed from the straight sheet metal. Further, the end piece of the first lower preloading element 13 is again bent by approximately 90°, in order to form the first spacing element 14.

Likewise, the second holding element 21 comprises a second upper preloading element 22 and a second lower preloading element 23, as well as a second spacing element 14. The second holding element 21 is also designed as a wing in the embodiment according to FIG. 1, which may be provided by bending a sheet metal by approximately 180°, in order to form the second upper preloading element 22 and the second lower preloading element 23. Here also, the end piece of the second lower preloading element 23 is again bent by approximately 90°, in order to form the second spacing element 24.

As shown in FIG. 1, the holding arrangement 10 has (mirror) symmetry along the (theoretical) plane of symmetry 60, which runs through the center of the fastening arrangement 50 and the holding arrangement 10. This means that the first holding element 11 and the second holding element 21 are arranged symmetrically; have, in particular, the same spacing from the center of the holding arrangement 10 and the fastening arrangement 50; and are the same size when formed. This allows the installation clip 1 to be used rotated as needed for installing assembly pieces, especially planks.

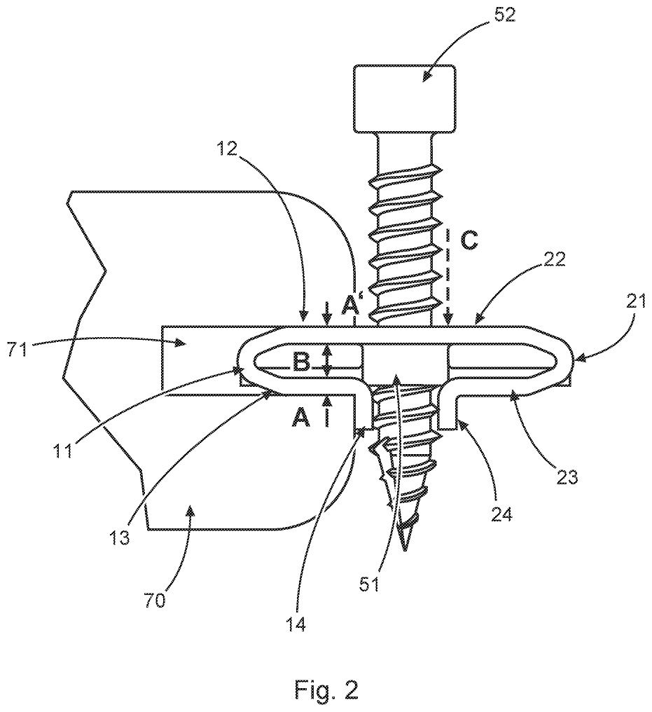

FIG. 2 shows a lateral arrangement of an installation clip 1 according to FIG. 1 inside an assembly piece 70. FIG. 2 shows a lateral view of an installation system consisting of an installation clip 1 and a fastening means 52 according to one or more embodiments, wherein the installation system is arranged inside an assembly piece 70.

In the specific embodiment according to FIG. 2, the fastening means 52 is implemented as a screw. Accordingly, the fastening recess 51 of the installation clip 1 is implemented as a thread. The first holding element 11 is implemented as a wing with a first upper preloading element 12 and a first lower preloading element 13 as well as a spacing element 14, that may be formed as described in connection with FIG. 1. The first assembly piece 70 comprises a first receiving element 71. In the specific embodiment according to FIG. 2, the first assembly piece 70 is implemented as a plank that comprises a groove as first receiving element 71.

For installation, the first holding element 11 is inserted into the first receiving element 71 until the first holding element 11 strikes, with the spacing element 14, the outer side of the first receiving element 71 of the first assembly piece 70. At this point, the insertion of the holding element 11 is stopped. The first upper preloading element 12 and the first lower preloading element 13 are brought closer together upon insertion, i.e., are pressed together, by mechanical pressure. The direction of this mechanical compressive force is labeled in FIG. 2 by the arrows A, A′. This compressive force works against a spring force of the wing. The direction of this spring force is labeled in FIG. 2 by the arrow B. Due to the spring force working against this pressing together, a preload is created inside the first receiving element 71, which holds the holding element 11 in position.

It is now possible to arrange a second assembly piece (not shown in FIG. 2) at the second holding element 21 of the installation clip 1. For this purpose, analogous to the first holding element 11, the second holding element 21 is inserted into a second receiving element (not shown) of the second assembly piece, until the insertion is stopped by the second spacing element 24. Here, the second upper preloading element 22 and the second lower preloading element 23 are brought closer together during the insertion and, due to the spring force working against the mechanical compressive force, exert a preloading that holds the second holding element 21 in position.

By stopping the insertion of the first holding element 11 into the first receiving element 71 of the first assembly piece 70 by way of the first spacing element 14 and by stopping the insertion of the second holding element 21 into the second receiving element of the second assembly piece by way of the second spacing element 24, it is ensured that the assembly pieces installed using the installation clip 1 have a defined spacing relative to one another. In the specific embodiment according to FIG. 2, in which the assembly pieces are implemented as planks, this means that the spacing elements 14 and 24 can guarantee a defined spacing between grooves.

After arranging the two assembly pieces 70 on the holding arrangement 10, the fastening means 52 is tightened for fastening. In the specific embodiment according to FIG. 2, in which the fastening means 52 is implemented as a screw, this means that the screw is tightened inside the fastening recess 51, i.e., inside the thread. During tightening, the screw exerts a force on the holding arrangement. The direction of this force is labeled in FIG. 2 with an arrow C. Due to the force exerted by the screw, the height of the first holding element 11 and the height of the second holding element 21 can be adjusted. The screw therefore allows for adjusting the height of the assembly piece, i.e., the height of the planks, in the specific embodiment according to FIG. 2. This makes it possible to use one and the same installation clip 1 for different plank heights.

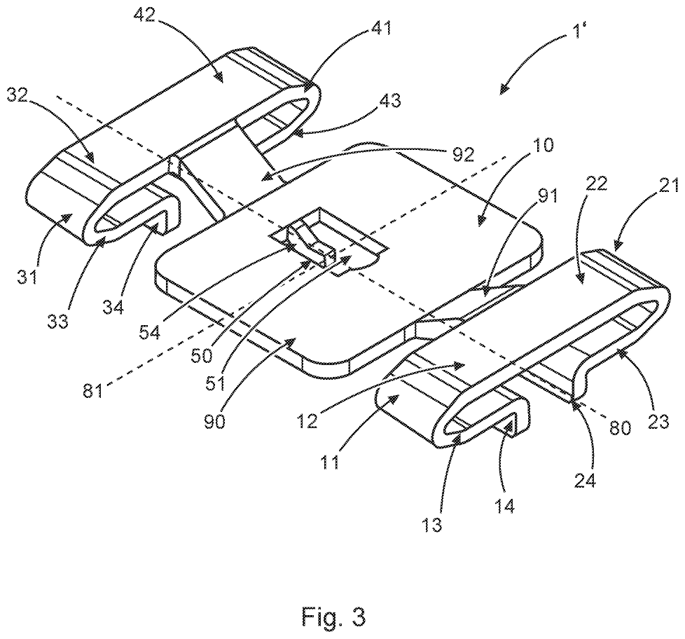

FIG. 3 shows an installation clip 1′ according to a second embodiment of the disclosure. As shown in FIG. 3, the installation clip 1′ comprises a first holding element 11 and a second holding element 21, as well as a third holding element 31 and a fourth holding element 41. Here, the first holding element 11 and the second holding element 21, as well as the third holding element 31 and the fourth holding element 41, are symmetrical relative to one another along a first plane of symmetry 80, the (approximate) extension of which is indicated by the dashed line in FIG. 3. Furthermore, the first holding element 11 and the second holding element 21 are symmetrical relative to the third holding element 31 and the fourth holding element 41 along a second plane of symmetry 81, the (approximate) extension of which is indicated by the dotted line in FIG. 3.

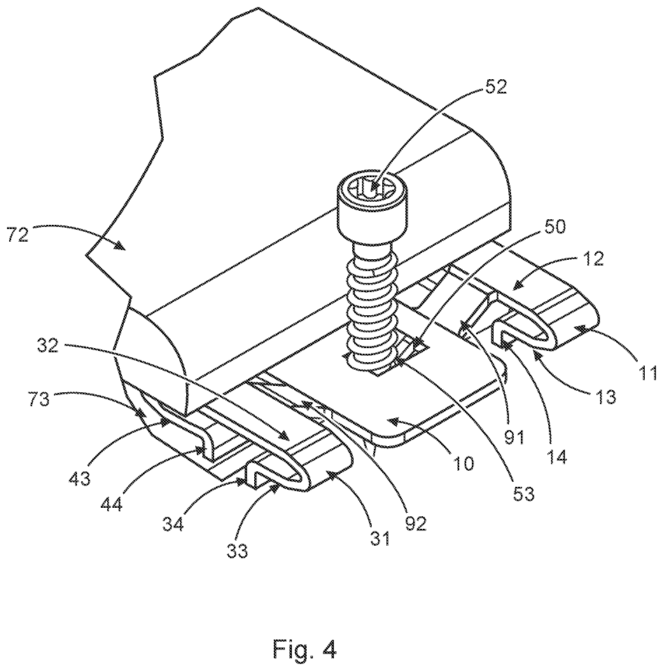

The functioning of all four holding elements resembles that of the others and is as described in connection with FIG. 2, wherein in the specific embodiment according to FIG. 3, both the first holding element 11 as well as the third holding element 31 are received in the first receiving element 71 of the first assembly piece 70, and correspondingly both the second holding element 21 as well as the fourth holding element 41 are received in the second receiving element of the second assembly piece, as described in more detail in connection with FIGS. 2 and 4.

In the second embodiment according to FIG. 3, the holding arrangement 10 comprises a body 90, in which the fastening arrangement 50 is arranged. The first holding element 11 and the second holding element 21 are connected to the body 90 by a first lever 91. Furthermore, the third holding element 31 and the fourth holding element 41 are connected to the body 90 by a second lever 92.

The fastening arrangement 50 of the second embodiment according to FIG. 3 also comprises a first lever device (not shown) and a second lever device 54 inside the fastening recess 51. From the perspective of the second plane of symmetry 81, the first lever device is disposed on the side of the first holding element 11 and of the second holding element, and the second lever device 53 is disposed on the side of the third holding element 31 and of the fourth holding element 41.

The functioning of the installation clip 1′ according to FIG. 3 is explained in more detail below based on the installation system as shown in FIG. 4. FIG. 4 shows an installation system according to an embodiment of the disclosure, comprising an installation clip 1′ as described above, especially an installation clip 1′ with a first holding element 11, a second holding element 21, a third holding element 31 and a fourth holding element 41. In the embodiment according to FIG. 4, the second holding element 21 and the fourth holding element 41 are arranged in a second receiving element 73 of a second assembly piece 72. In the specific embodiment according to FIG. 4, the second assembly piece 72 is implemented as a plank that comprises a groove as a second receiving element 73. The functioning of the installation clip according to FIG. 3 upon insertion into the second receiving element 73 corresponds to the functioning as described in connection with FIG. 2.

Here as well, the fastening means 52 is implemented as a screw. The installation clip comprises four holding elements 11, 21, 31, 41, whereby in the embodiment according to FIG. 4, the second holding element 21 (not shown) and the fourth holding element 41 opposite the second holding element 21 along the second plane of symmetry are arranged in the second receiving element 73 of the second assembly piece 72.

Both the second holding element 21 as well as the fourth holding element 41 are implemented as wings with a second upper preloading element and a second lower preloading element, as well as a second spacing element (none shown) and a fourth upper preloading element 42 and a fourth lower preloading element 43, as well as a fourth spacing element 44, which may be formed as described in connection with FIG. 1. The same also applies analogously to the first holding element 11, which is also equipped as a wing with a first upper preloading element 12 and a first lower preloading element 13, as well as a first spacing element 14, and to the third holding element 31, which is implemented as a wing with a third upper preloading element 32 and a third lower preloading element 33 as well as a third spacing element 34.

For installation, the second holding element 21 and the fourth holding element 41 are inserted into the second receiving element 73 until both, with their respective spacing elements 24, 44, come into contact with the outer side of the second receiving element 73 of the second assembly piece 72 and are stopped there, as described in connection with FIG. 2. This stop ensures that when joining the second assembly piece 72 and the first assembly piece 70 using the installation clip 1, a defined spacing between the assembly pieces can be guaranteed.

Here, the second upper preloading element 22 and the second lower preloading element 23, and the fourth upper preloading element 42 and the fourth lower preloading element 43 are pressed together through mechanical pressure upon insertion into the second receiving element 73. This compressive force is counteracted by a spring force of the two wings, which represent the second holding element 21 and the fourth holding element 41. Due to the spring force working against this pressing together, the corresponding preload that holds the second holding element 21 and the fourth holding element 41 in position is created inside the second receiving element 73. Analogously, the first assembly piece can be installed using the first holding element 11 and the third holding element 31.

One difference compared to the embodiment according to FIG. 2 consists in the fastening using the fastening means 52, which is also implemented as a screw in FIG. 4. When the fastening means 52 is tightened, it exerts a force on the first lever device (not shown) and the second lever device 54. This force is transferred to the first lever 91 and to the second lever 92, which raise the four holding elements 11, 21, 31 and 41 in response to the exertion of force and it is thereby made possible to adjust the height of the first assembly piece (not shown) and of the second assembly piece 72. In the specific embodiment according to FIG. 4, both assembly pieces are planks, the height of which can be set by means of the lever effect exerted by the fastening means 52. This makes it possible to use one and the same installation clip 1′ for different plank heights.

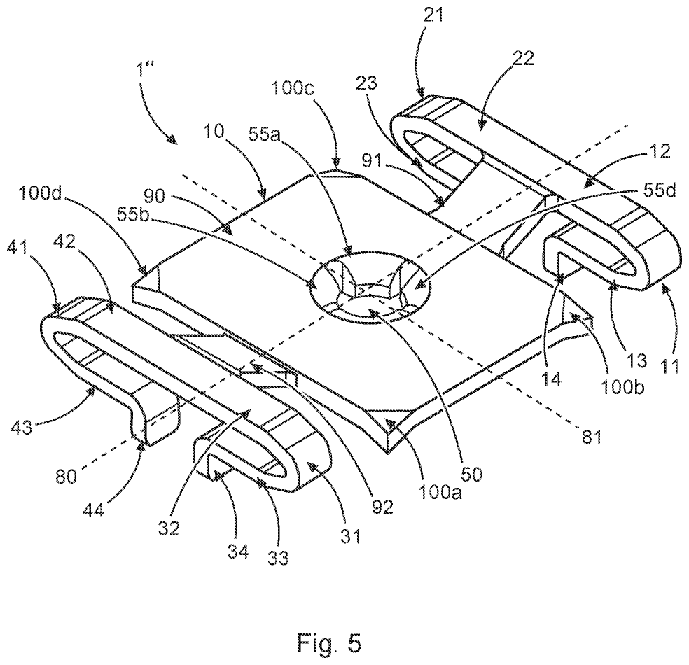

FIG. 5 shows an installation clip 1″ according to a third embodiment that may be a further development of the installation clip 1′ according to FIG. 3. The installation clip 1″ may have elements similar to those described above with regards to the installation clip 1′. In particular, in the embodiment according to FIG. 5, the installation clip 1″ comprises a first holding element 11 and a second holding element 21, as well as a third holding element 31 and a fourth holding element 41, which are arranged symmetrically relative to the planes of symmetry 80 and 81, as described in connection with FIG. 3.

The functioning of all four holding elements 11, 21, 31, 41 is the same here as well for all four holding elements. This means that the holding elements 11, 21, 31, 41 function as described in connection with FIGS. 2 and 4. In FIG. 5 as well, both the first holding element 11 as well as the third holding element 31 are received into the first receiving element 71 of the first assembly piece 70 and analogously, both the second holding element 21 as well as the fourth holding element 41 are received into the second receiving element 73 of the second assembly piece 72.

In FIG. 5 as well, the holding arrangement 10 comprises a body 90, in which the fastening arrangement 50 is arranged. The first holding element 11 and the second holding element 21 are connected to the body 90 by a first lever 91. Furthermore, the third holding element 31 and the fourth holding element 41 are connected to the body 90 by a second lever 92.

A first difference compared to the second embodiment according to FIG. 3 consists in that the fastening arrangement 50 according to FIG. 5 does not comprise a lever device, but rather four projections 55a, 55b, 55c (not shown) and 55d arranged in a cross pattern. The cross pattern-arrangement of the four projections ensures that the projections are arranged at the same spacing from one another within the fastening arrangement 50, whereby the center of the four projections is respectively oriented at approximately a 45° angle relative to the first or second plane of symmetry 80, 81, respectively.

The projections 55a, 55b, 55c and 55d also make it possible to adjust the height of the first and second assembly piece, similar to how it is described in connection with FIG. 3. When the fastening means 52 is tightened, especially the screw, a force acts on the projections 55a, 55b, 55c and 55d, which force is transmitted to the holding elements 11, 21, 31 and 41, and in this manner makes it possible to adjust the height of the first assembly piece 70 and of the second assembly piece 72.

Another difference compared to the second embodiment according to FIG. 3 consists in that the body 90 of the holding arrangement 10 has four sharp edges 100a, 100b, 100c and 100d. These sharp edges 100a, 100b, 100c and 100d are respectively arranged at the corners of the body 90. The edges 100a, 100b, 100c and 100d improve assembly of the first assembly piece 70 and of the second assembly piece 72, when the installation clip 1″ is finally fastened by the fastening means 52.

Upon tightening, a force is exerted on the body from above, which ensures that the sharp edges 100a and 100b are pressed into the first receiving element 71 of the first assembly piece 70 and possibly penetrate into it. This provides an additional securing of the body 90 inside the first receiving element 71. Equally, upon fastening, the sharp edges 100c and 100d are pressed into and/or penetrate into the second receiving element 73 of the second assembly piece 72, whereby the body 90 is additionally secured inside the second receiving element 72.

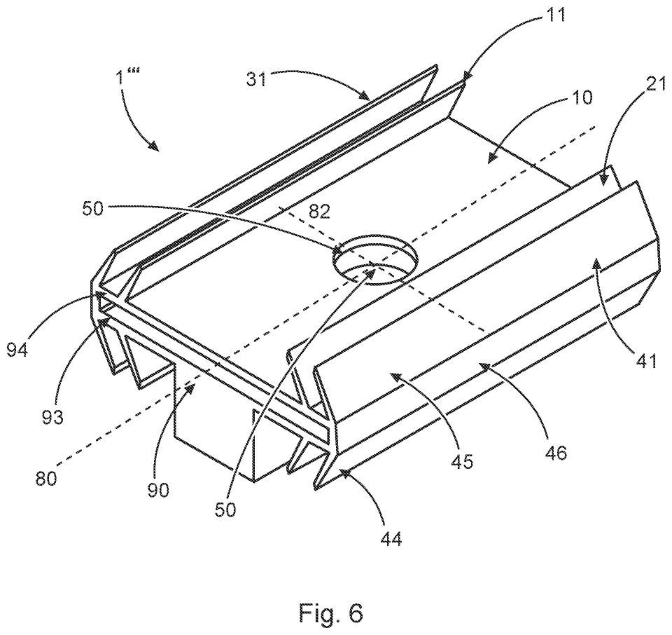

FIG. 6 shows an installation clip 1″′ according to a fourth embodiment of the disclosure. The installation clip 1″′ also comprises a holding arrangement 10 with a first holding element 11, a second holding element 21, a third holding element 31 and a fourth holding element 41. Here as well, the first holding element 11 and the third holding element 31 are arranged symmetrically relative to the second holding element 21 and the fourth holding element 41. In the fourth embodiment according to FIG. 6 as well, the first holding element 11 and the third holding element 31 are received by the first receiving element 71 of the assembly piece 70. Analogously, the second holding element 21 and the fourth holding element 41 are received into the second receiving element 73 of the second assembly piece 72.

Different from the second and the third embodiment, the first holding element 11 and the third holding element 31, as well as respectively the second holding element 21 and the fourth holding element 41 are not symmetrical to one another along a second plane of symmetry 81. Instead, the first holding element 11 and the third holding element 31, as well as respectively the second holding element 21 and the fourth holding element 41, are arranged sequentially along a normal 82 passing through the first plane of symmetry 80. This means that the first holding element 11 is arranged closer to the plane of symmetry 80 running through the center of the holding arrangement 10 than the third holding element 31. In the same way, the second holding element 21 is arranged closer to the plane of symmetry 80 than the fourth holding element 41.

Another difference compared to the second and third embodiment consists in the forming of the holding elements, as described below based on the fourth holding element 41 as an example. The fourth holding element 41 comprises a first beveled surface 44 and a second beveled surface 45. The fourth holding element 41 further comprises a parallel surface 46. The beveled surface 44 is attached to the parallel surface 46 and the parallel surface 46 is attached to the beveled surface 45, in order to form the fourth holding element 41.

In the specific embodiment according to FIG. 6, the third holding element 31 is also formed with two beveled surfaces and a parallel surface connecting them. The first holding element 11 and the second holding element 21 also respectively have two beveled surfaces. Different from the third holding element 31 and the fourth holding element 41, the first holding element 11 and the second holding element 21 do not have a parallel surface. Instead, the first beveled surface and the second beveled surface, of the first holding element 11 and the second holding element 21, respectively, are connected to one another by a body 90 of the holding arrangement 10. In other embodiments, however, the first holding element 11 and the second holding element 21 can have also, alternatively or in addition, corresponding parallel surfaces that connect the beveled surfaces.

In this embodiment, the body 90 of the installation clip 1″′ from the fourth embodiment is designed as two surfaces 93 and 94 running parallel to one another, wherein the spacing between the first surface 93 and the second surface 94 corresponds to the width of the parallel surface of the third holding element 31 and the width of the parallel surface 46 of the fourth holding element 41.

The fourth embodiment according to FIG. 6 further comprises a fastening arrangement 50. The fastening arrangement 50 can be designed as described in connection with any one of FIGS. 1, 3 and 5. At this point, it should be understood that the installation clip 1″′ according to the fourth embodiment is not limited to a certain fastening arrangement.

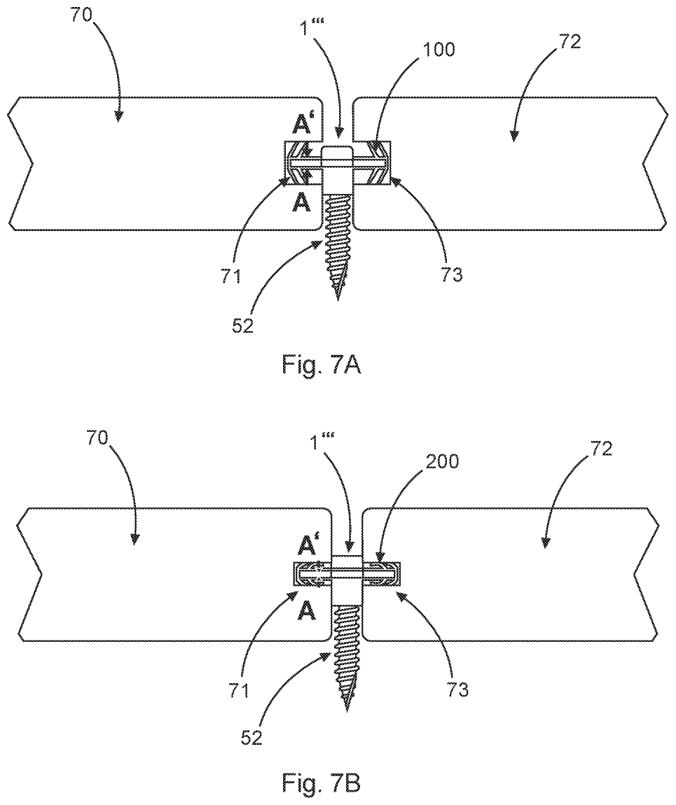

The functioning of the installation clip 1″′ is now explained in connection with FIGS. 7A and 7B. FIG. 7A shows the installation clip 1″′ from the fourth embodiment in a first fastening position 100. FIG. 7B shows the installation clip 1″′ from the fourth embodiment in a second fastening position 200.

To this end, the installation clip 1′, with the first holding element and the third holding element, is received in the first receiving element 71 of the first assembly piece 70, and with the second holding element and the fourth holding element, is received into the second receiving element 73 of the second assembly piece 72. Here, the first receiving element 71 exerts a force on the first and the third holding element, and the second receiving element 73 exerts a force on the second and the fourth holding element, such that the beveled surfaces of the holding elements are pressed in the direction of the body 90. This pressure direction is indicated schematically in FIGS. 7A and 7B by the arrows A, A′.

The extent to which the beveled surfaces of the holding element are curved in the direction of the body 90 depends on how large the first receiving element 71 and the second receiving element 73, respectively, are. For instance, in the second fastening position 200, the beveled surfaces lie almost on the body 90, whereas in the first fastening position 100, the beveled surfaces are almost in their original position. In this case as well, the final fastening is done by means of the fastening element 52, which is fastened inside the fastening recess 51. The height of the planks is automatically set in the case of the installation clip 1″′ from the fourth embodiment. This enables an especially efficient installation.

One advantage of this fourth embodiment includes enabling an especially stable fastening for receiving elements designed to be flexible in size. In particular, one and the same installation clip 1″′ can be used for receiving elements, especially grooves, of different heights. This high degree of variability of the installation clip 1″′ has the effect that the installation clip 1″′ can be used universally. This simplifies not only the assembly—since a special installation clip 1″′ does not have to be specifically selected for the receiving element—but rather also has advantageous effects for inventory stocking, since here merely a universally-usable installation clip 1″′ that is suitable for working with all common receiving elements, especially grooves, has to be kept in stock.

The embodiments described above should be understood as examples and should not be understood to have a restrictive effect; in particular, the invention is not limited to these specific embodiments, but rather comprises all installation clips, the holding arrangements of which have multiple holding elements which themselves are configured to be held in position by means of a preloading inside the receiving elements of assembly pieces, especially in grooves of planks, before their final fastening, as well as all installation clips that make it possible to adjust the assembly piece height, especially the plank height, and/or enable a pre-setting of the spacing between the assembled assembly pieces, especially a pre-setting of the groove spacing.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An installation clip for installing assembly pieces comprising:
a holding arrangement with a first holding element and a second holding element, wherein the first holding element and the second holding element are arranged symmetrically inside the holding arrangement, wherein the first holding element is configured to interlock with a first receiving element of a first assembly piece and the second holding element is configured to interlock with a second receiving element of a second assembly piece; wherein
the first holding element and the second holding element are configured elastically to be held by a preload inside the first receiving element and the second receiving element.

2. The installation clip according to claim 1, further comprising:
a fastening arrangement having a fastening recess.

3. The installation clip according to claim 2, wherein the first holding element is configured as a first wing and the second holding element is configured as a second wing.

4. The installation clip according to claim 3,
wherein the first wing comprises a first upper preloading element and a first lower preloading element, and the first upper preloading element and the first lower preloading element are disposed opposite one another in order to create the preload for the first holding element upon being received into the first receiving element; and
wherein the second wing comprises a second upper preloading element and a second lower preloading element, and the second upper preloading element and the second lower preloading element are disposed opposite one another in order to create the preload for the second holding element upon being received into the second receiving element.

5. The installation clip according to claim 1, wherein the first holding element comprises a first spacing element and the second holding element comprises a second spacing element, wherein the first spacing element is configured to set a penetration depth of the first holding element into the first receiving element and the second spacing element is configured to set a penetration depth of the second holding element into the second receiving element in order to define a spacing between the assembly pieces.

6. The installation clip according to claim 1, wherein the first receiving element comprises a first groove and the second receiving element comprises a second groove, wherein the first holding element and the second holding element are configured to interact with the first groove and the second groove in order to respectively create the preload.

7. The installation clip according to claim 1, wherein the holding arrangement further comprises a third holding element and a fourth holding element, wherein the third holding element and the fourth holding element are arranged symmetrically inside the holding arrangement, wherein the third holding element is configured to interlock with the first receiving element of the first assembly piece and the fourth holding element is configured to interlock with the second receiving element of the second assembly piece; wherein
the third holding element and the fourth holding element are configured elastically to be held by a preload inside the first receiving element and the second receiving element.

8. The installation clip according to claim 1, wherein an installation height of the installation clip is variable, said variability being obtained by setting the at least one fastening element in the fastening recess of the at least one installation clip.

9. An installation system for installing assembly pieces comprising:
an installation clip including a holding arrangement with a first holding element and a second holding element, wherein the first holding element and the second holding element are arranged symmetrically inside the holding arrangement, wherein the first holding element is configured to interlock with a first receiving element of a first assembly piece and the second holding element is configured to interlock with a second receiving element of a second assembly piece, wherein the first holding element and the second holding element are configured elastically to be held by a preload inside the first receiving element and the second receiving element, the installation clip further including a fastening arrangement having a fastening recess; and
a fastening element configured to be received into the fastening recess.

10. The installation system according to claim 9, wherein the fastening element is further configured to set a height of the first assembly piece and of the second assembly piece.

11. The installation system according to claim 9, wherein the fastening element comprises a screw.

12. The installation system according to claim 9 further comprising at least two assembly pieces, wherein the at least two assembly pieces can be installed using the at least one installation system in a horizontal or vertical orientation.

13. A method for producing an installation clip for installing assembly pieces comprising:
providing a holding arrangement with a first holding element and a second holding element;
symmetrically arranging the first holding element and the second holding element inside the holding arrangement;
shaping the first holding element in order to interlock with a first receiving element of a first assembly piece;
shaping the second holding element in order to interlock with a second receiving element of a second assembly piece; and
configuring the first holding element and the second holding element as elastic elements that are configured to be held inside the first receiving element and the second receiving element by a preload.
